(19) United States
(12) Patent Application Publication
(10) Pub. No.: US 2002/0005931 A1
(43) Pub. Date: Jan. 17, 2002

(54) Diving mask

(76) Inventor: Pan Chen-Lieh, Yuan Shan Shiang (TW)

Correspondence Address: Dougherty & Troxell, Suite 1404, 5205 Leesburg Pike, Falls Church, VA, 22041, US

(21) Appl. No.: 09/568,159

(22) Filed: May 10, 2000

(30) Foreign Application Priority Data
Feb. 29, 2000 (TW) 89203167

(51) Int. Cl. G02C 1/00

(52) U.S. Cl. 351/43; 351/41

(57) ABSTRACT

A diving mask, especially, its lens can provide wide view field, which is formed by connection of multiple glasses, a glue, a glue with elastic and flexible is connected between the glasses, the tangent plane of conected plane between the glasses is designed as overlap or paralled with the line of sight; a diving mask with wide view field is constituted by means of the lens for abovementioned constitution connecting with sub-frame, skirt and main frame.

### FIELD OF THE INVENTION

The present invention relates to a diving mask, especially, to providing a lens with wider view field and frame structure.

### BACKGROUND OF THE INVENTION

The angle of view field provided by general diving mask with single viewing window(single lens) or double viewing windows(double lenses) is narrow than the ordinary view field of person; The diving mask with three viewing windows or four viewing windows is commercially available at present (such as M30, M40 producted by TABATA CO. CTD; Hawaii 3 producted by Aqua Lung America, Inc., WM-7302P, WM-7401 producted by UNIDIVE DIVING INDUSTRY CO., LTD ect), its left-right both side viewing windows are the viewing window integrating the transparent material with frame body or inserting two pieces of plane glasses in left-right both sides. The diving mask provided by above-mentioned three viewing windows or four viewing windows is practically limited to the “frame edge” (as shown in FIG. 6) which is provided between the front viewing window and left-right viewing windows, the view field is influenced, so that the effect is not good.

According to the above-mentioned position, there is than a such design which is made of curved glass and can provide wide view field, but which is not popularized because the cost of building is too expensive. Studying its cause is in that the glass used as lens must use the “tempered glass” which is not easily broken or a sharp and dangerious state should be not formed during breaking, most tempered glasses are planar, when a non-planar state is to be made, it is not only difficult in manufacturing, but also in very expensive cost and is not adaptable to mass production; otherwise, some problems of qulity such as thickness, planeness transparency are not easily overcome.

### SUMMARY OF THE INVENTION

The present invention is a diving mask which can provide a wider view field, especially relates to its lens structure, a lens providing front and side view field is connected by use of “tempered glass” with “tempered glass” in gluey fashion, a structure without longitudinal frame between the front viewing window and the side viewing window of the diving mask is formed by means of the lenses which are connected with sub-frame, skirt and main frame.

The slope-connection plane for the gluey position between above-mentioned glasses is disigned with an angle which is parallel (or overlap) with “line of sight”, which is only a thin line, so that hindrance or influence to the view field is very slight.

The glue for connection between above-mentioned glasses can be UV silicone glue which can provide not only a good connection, and water proof, but also having elastic and flexible between glasses, so that movement with small angle between two glasses can be made.

The lens structures can be guled by glass which is more than two pieses (such as three pieces or four pieces etc.), when using the above-mentioned constitutional characteristics.

The lens of the diving mask can be a single lens or there is lens on each left-right side, when using the above-mentioned constitutional characteristics.

The problems of safety, mass production and cost related to the diving mask can be solved because the lens structure provided by the present invention can use “planar” “tempered glass” as the material, except that which can provide wider view field during diving.

### BRIEF DESCRIPTION OF THE DRAWINGS

FIG. 1 is a perspective exploded view of the present invention.

FIG. 2 is a perspective view of the invention.

FIG. 3 is a schematic view of fitting state for the lens of the present invention with the line of sight.

FIG. 4 is a perspective view of another embodiment for the lens of the present invention.

FIG. 5 is a view of another embodiment for the diving mask of the present invention.

FIG. 6 is a conventional diving mask.

### DETAILED DESCRIPTION OF THE INVENTION

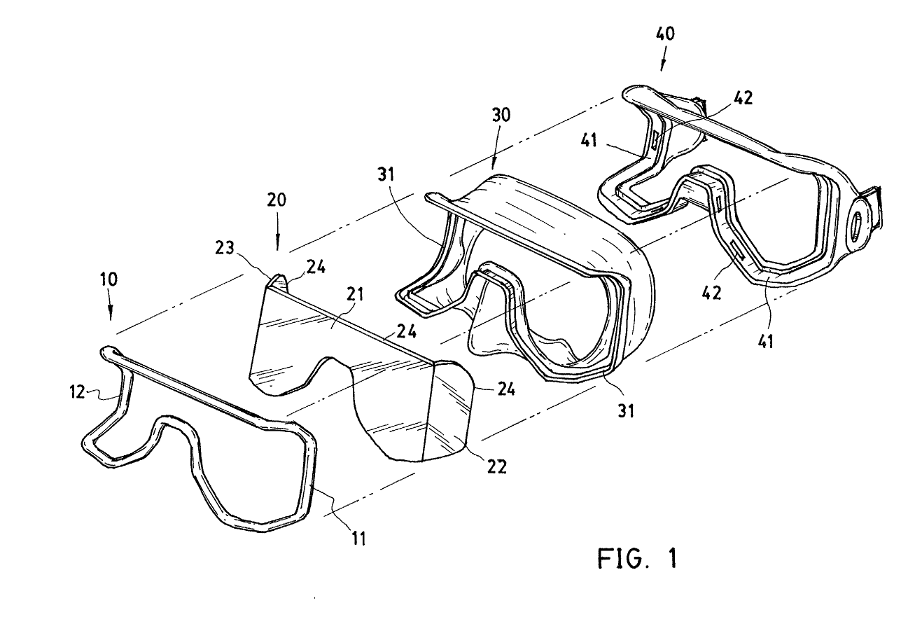

As shown in FIG. 1, the constitution of the present invention includes a sub-frame 10, one lens 20, skirt 30 and a main frame 40.

The sub-frame 10 is provided in the front of the lens 20, which can be integrated with the main frame 40 by means of the clicking member fashion, the lens 20 and the frame edge 31 of the skirt 30 are clicked between both sides, Both side frames 11-12 of the sub-frame 10 structure for the present invention are in sweepback state, its sweepback angle is fitted with the form of lens 20.

The lens 20 includes front glass 21 and side glasses 22 [symbol] 23 in its sides. The place between front glass 21 and side glasses 22 [symbol] 23 is connected by glue, water or liquid can not be passed through therein, the glue can select materials as UV silicone glue, except that which is having watertight function, also having quite elastic and flexible, the watertight connecting state can be remained under the state in which the place between front glass 21 and side glasses 22 [symbol] 23 is slight deformed.

The skirt 30 is provided behing the lens 20, is made from transparent plastic materials(such as clear silicone etc.), the frame edge 31 of the skirt 30 is fitted with the edge 24 of the lens 20, and is connected in the frame slot 41 of the main frame 40.

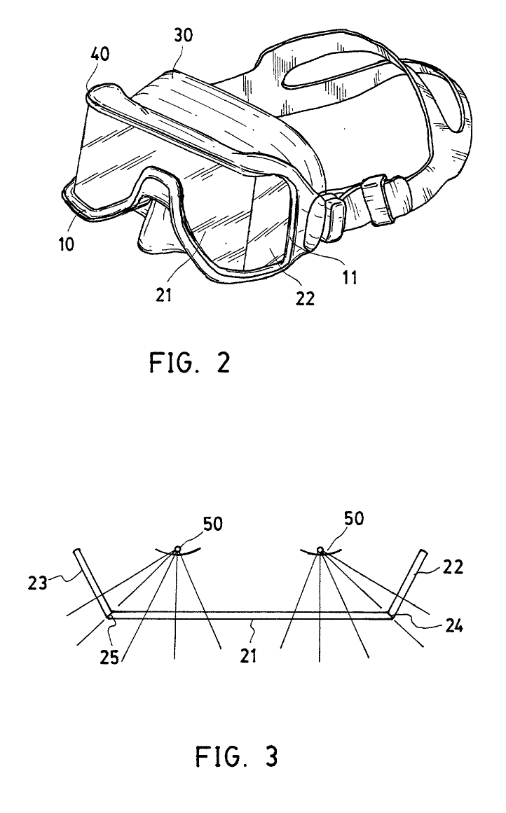

The main frame 40 is analogous to conventional main frame, the frame slot 41 and several connecting clicking members 42 are provided thereon, sub-frame 10, lens 20 and frame edge 31 are placed on the frame slot 41, and the diving mask is connected in a stabile state by means of the connection between the connecting clicking member 42 and clicking memeber (not shown) of sub-frame 10 (as shown in FIG. 2).

The schematic view of fitting state for the lens 20 with the line of sight for eyes 50 is as shown in FIG. 3, the connected planes 24 [symbol] 25 are between the front glass 21 and side glasses 22 [symbol] 23, the direction of its tangent plane and the direction for line of sight for eyes 50 are designed in parallel or overlap state, so that the influence of the conneced plane 24 [symbol] 25 on the line of sight for user is slight.

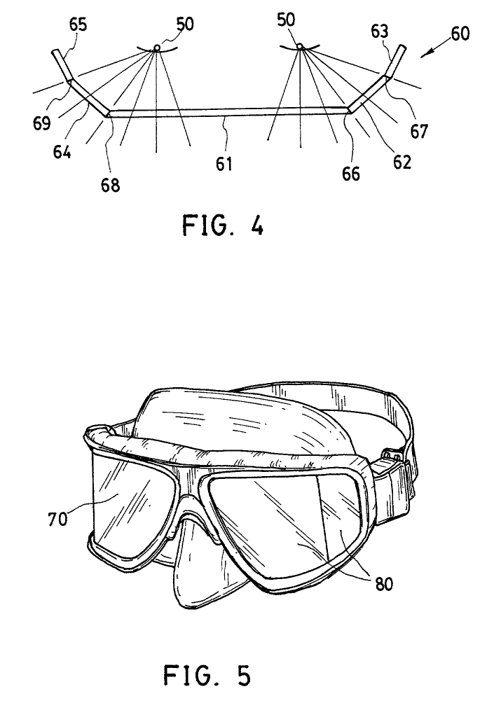

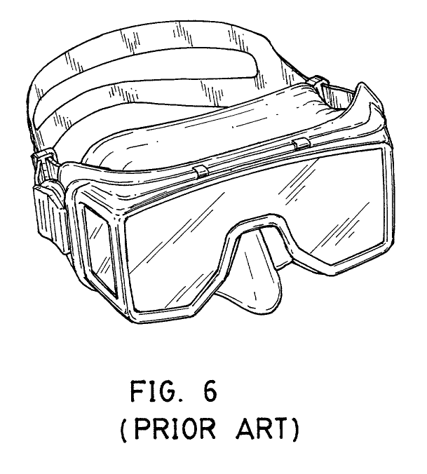

Another embodiment of the lens is as shown in FIG. 4, except that front glass 61, there is multiple-glass structure provided on each side of the lens 60, i.e. the side glass 62 [symbol] 63 [symbol] 64 [symbol] 65 are provided on each its side, and the tangent planes of each connected plane 66 [symbol] 67 [symbol] 68 [symbol] 69 therein are fitted with the line of sight.

The embodiment of another diving mask is as shown in FIG. 5, wherein there are two lenses 70, 80 provided on each left-right side.

The above-mentioned are embodiments, the main characteristic of the present invention is “lens” part, as regards, the structure of sub-frame, skirt and main frame or the connecting fashion as not limited to the above-mentioned description.

1. A diving mask with wide view field, its constitution includes a sub-frame, a lens, a skirt and a main frame:
sub-frame: its frame edge is fitted with frame edge of lens, its clicking lens and skirt are integrated with the main frame;
lens: which is connected by front glass and side glass of both sides in gluey fashion;
skirt: which has a frame edge connecting periphery of lens, the frame edge can place in the frame slot of main frame;
main frame: which has a frame slot connecting periphery of skirt and lens, frame edge of sub-frame, can be integrated with the sub-frame;
the characteristic of above-mentioned constitution is having a lens with wide view field, the diving mask connected with sub-frame, skirt and main frame can provide a wider view filed.

2. The diving mask as claimed in claim 1, wherein said the glue between the front glass and the side glasses is a material having elastic and flexible.

3. The diving mask as claimed in claim 1, wherein the connected plane between the front glass and the side glasses is toward paralled or overlap state with the line of sight for eye during using state.

4. The diving mask as claimed in claim 1, wherein the lens is connected with multiple glasses.

5. The diving mask as claimed in claim 1, wherein the lens can be multiple glass structure which is in each left-right side.
